(19) United States
(12) Patent Application Publication
(10) Pub. No.: US 2011/0029349 A1
(43) Pub. Date: Feb. 3, 2011

(54) SYSTEM, COMPUTER-ACCESSIBLE MEDIUM AND METHOD FOR PROVIDING WORKER DISTRIBUTION PLAN ON BASIS OF PRIORITY

(75) Inventor: Toshiyuki Omiya, Tokyo (JP)

Correspondence Address: DORSEY & WHITNEY LLP;INTELLECTUAL PROPERTY DEPARTMENT, 250 PARK AVENUE, NEW YORK, NY, 10177, US

(73) Assignee: P&W Solutions Co., Ltd., Tokyo (JP)

(21) Appl. No.: 12/375,817

(22) PCT Filed: Jul. 31, 2007
(86) PCT No.: PCT/JP2007/064982

§ 371 Date: Nov. 30, 2009

(30) Foreign Application Priority Data
Jul. 31, 2006 (JP) 2006-208959

(51) Int. Cl. G06Q 10/00

(52) U.S. Cl. 705/9

(57) ABSTRACT

A method for making a worker distribution plan on the basis of the priority, a computer, and a program are provided. A computer (10) makes skill level data the top priority and selects workers to be assigned to each work for each predetermined period in descending order of the skill level data according to necessary worker data indicating the number of workers having a necessary skill for each work and for each predetermined period calculated from the predicted value of workload for each predetermined period and priority data indicating the priority for each set of attribute item data and used for selecting workers to be assigned to the work.

### TECHNICAL FIELD

The present invention relates to a method for making a worker distribution plan on the basis of priority, computer, and program.

### BACKGROUND ART

In a business center called a “call center” or a “contact center”, assignment plans (scheduling) of workers called “operators” or “communicators” in charge of tasks of responding to inquiries from clients by telephone or e-mail, or of carrying out solicitations for products or services or for reminders of receivables, is an important task influencing productivity of this type of business center.

Conventionally, in this type of business center, a manager carrying out an assignment plan (scheduling) of workers created an assignment plan for individual task units (campaigns) based on work efficiency perceived as a worker's past average handle time (AHT) or qualitative skill level information. Furthermore, a method of automatically creating an assignment plan of workers based on such various conditions as AHT and the like has been proposed.

Patent Document: 1 Japanese Unexamined Patent Application Publication No. 2003-157343

### DISCLOSURE OF THE INVENTION

### Problems to be Solved by the Invention

However, the method of automatically creating an assignment plan of workers by the technology of Patent Document 1, while being based on such various conditions as AHT and the like, did not adequately meet needs of an assignment plan for each client in relation to such various attribute information as skill level or work efficiency of workers.

More specifically, there was the issue that it was not possible to create a worker assignment plan appropriately reflecting a priority concerning attribute information for the worker assignment plan.

Therefore, in the present invention, an objective thereof is to provide a method for carrying out an assignment plan for each worker based on a priority relating to attribute information of workers.

### Means for Solving the Problems

The present invention, more specifically, provides the following.

According to a first aspect of the present invention, in a method of a computer selecting a worker to be assigned for each task, the computer storing in a storage unit:

a table of skill attributive items of workers including at least a worker ID identifying a worker, a skill ID identifying a skill of the worker, and data of attribute items associated with the worker ID and the skill ID; and

a table of priority data including at least data of attribute items and data of priority, in which:

the data of attribute items is configured to include at least data of skill levels representing a degree of proficiency of the skill;

the priority data represents a priority of each of the data of attribute items for the purpose of selecting a worker to be assigned to the task, the method including:

a step of assigning a highest order to the priority of the data of skill levels; and

a step of selecting a worker to be assigned for each of the tasks and the prescribed periods, based on data of required workers representing a number of workers having a required skill for each of the tasks and the prescribed periods, and the priority data, in order of descending values of the data of skill levels, the data of required workers being calculated from predicted values of workload for each prescribed period.

By including the configuration of the first aspect, the computer stores in the storage unit the table of skill attributive items of workers including at least a worker ID identifying the worker, a skill ID identifying the skills of the worker, and data of attribute items associated with the worker ID and the skill ID; and

the table of priority data including at least the data of attribute items and the data of priority; in which:

the data of attribute items is configured to include at least the data of skill levels representing a degree of proficiency of the skill;

the data of priority represents a priority for each of the data of attribute items, for the purpose of selecting a worker to be assigned to the task;

the computer assigns a highest order to the priority of the data of skill levels; and

the computer has an operational effect of being able to select a worker to be assigned for each of the tasks and the prescribed periods, based on the data of required workers representing a number of workers having a required skill for each of the tasks and the prescribed periods, in order of descending values of the data of skill levels, the data of required workers being calculated from predicted values of workload for each prescribed period.

As a result, it is possible for the computer to select a worker to be assigned for each task and prescribed period with priority of the data of skill levels being the highest order in order of descending values of the data of skill levels, based on the data of required workers calculated and the data of priority.

The result is that it is possible for the computer to select a worker based on the data of priority, and there is a possibility of being able to carry out an assignment plan minimizing excesses and deficiencies of workers and mismatches of skills.

According to a second aspect of the present invention, in the method as described in the first aspect, the data of attribute items further includes data of work efficiency calculated based on an average handle time for one task; and

the computer:

assigns a highest order to the priority of the data of work efficiency in the step of assigning a highest order to the priority, for a case in which values of the data of skill levels relating to a plurality of the worker ID's are mutually equal; and

selects the workers in descending order of values of the data of work efficiency in the step of selecting.

By including the configuration of the second aspect, the data of attribute items further includes data of work efficiency calculated based on an average handle time for one task; and

the computer has operational effects of being able to assign a highest order to the priority of the data of work efficiency in a step of assigning a highest order to the priority, for a case in which values of the data of skill levels relating to a plurality of the worker ID's are mutually equal, and

being able to select the workers in descending order of values of the data of work efficiency in the step of selecting.

As a result, in a case in which values of the data of skill levels relating to a plurality of workers are mutually equal, it is possible to assign a highest order to the priority of the data of work efficiency, and to select the workers in descending order of values of the data of work efficiency.

According to a third aspect of the present invention, in the method as described in the second aspect, the data of attribute items further includes data of affiliations representing an affiliation of the worker; and

the computer assigns a highest order to the priority of the data of affiliation in the step of assigning a highest order to the priority, for a case in which values of the data of skill levels relating to a plurality of the worker ID's are mutually equal, and values of the data of work efficiency relating to a plurality of the worker ID's are mutually equal, and

selects the workers based on a ratio of a number of the workers registered for each of the affiliations in the step of selecting.

By including the configuration of the third aspect, the data of attribute items further includes data of affiliations representing affiliations of the workers; and

the computer has an operational effects of being able to assign a highest order to the priority of the data of affiliations in the step of assigning a highest order to the priority, for a case in which values of the data of skill levels relating to a plurality of the worker ID's are mutually equal, and values of the data of work efficiency relating to a plurality of the worker ID's are mutually equal, and

being able to select the workers based on a ratio of a number of the workers registered for each of the affiliations in the step of selecting.

As a result, in a case in which values of the data of skill levels relating to a plurality of workers are mutually equal, and values of the data of work efficiency relating to a plurality of the worker ID's are mutually equal, it is possible to assign a highest order to the priority of the data of affiliations, and to select the workers based on a ratio of a number of the workers registered for each of the affiliations.

According to a fourth aspect of the present invention, in the method as described in the third aspect, the computer selects the workers by generating random numbers in the step of selecting, for a case in which values of the data of skill levels relating to the plurality of worker ID's are mutually equal, values of the data of work efficiency relating to the plurality of worker ID's are mutually equal, and values of the data of affiliations relating to the plurality of worker ID's are mutually equal.

By including the configuration of the fourth aspect, the computer has an operational effect of being able to select the workers based on generation of a random number in the step of selecting, for a case in which values of the data skill levels relating to the plurality of worker ID's are mutually equal, values of the data of work efficiency relating to the plurality of worker ID's are mutually equal, and values of the data of affiliation relating to the plurality of worker ID's are mutually equal.

As a result, in a case in which values of the skill level data relating to a plurality of worker ID's are mutually equal, values of work efficiency data relating to the plurality of worker ID's are mutually equal, and values of the affiliation data relating to the plurality of worker ID's are mutually equal, it is possible to select workers by generating a random number.

According to a fifth aspect of the present invention, in the method as described in the third or fourth aspect, the computer further includes a step of displaying on a display portion a number of workers for each of the affiliations of workers selected based on a ratio of a number of the workers registered for each of the affiliations, and accepting a modifying input of the number of workers displayed, and

in the step of selecting, based on a ratio of the number of workers for which the modifying input has been accepted, workers assigned for each prescribed period are re-selected.

By including the configuration of the fifth aspect, the computer has operational effects of being able to display on the display portion a number of workers for each of the affiliations of the selected workers based on a ratio of a number of the workers registered for each of the affiliations, and to accept a modifying input of the displayed number of workers; and

to re-select workers assigned for each of the prescribed periods in the step of selecting, based on a ratio of the number of workers for which the modifying input has been accepted.

As a result, since it is possible to re-select workers assigned to each affiliation in a prescribed period, it is possible to adjust a number of workers assigned of each affiliation in a prescribed period based on circumstances of a user.

According to a sixth aspect of the present invention, in the method as described in any of the first to fifth aspects, the computer further includes a step of accepting an input for configuring the priority data.

By including the configuration of the sixth aspect, the computer has an operational effect of being able to accept an input for configuring the priority data.

As a result, since it is possible for a client to directly input and designate a priority of attribute items for a purpose of an assignment plan for workers, it is possible to reflect requests of clients in a worker assignment plan.

As a result, it is possible to meet requests for each client, such as considering available hours per week or per month in making assignments, or in giving priority to workers who have not recently been assigned in assigning thereof.

According to a seventh aspect of the present invention, in a computer for selecting workers to be assigned for each task,

the computer storing in a storage unit: a table of skill attributive items including at least a worker ID identifying a worker, a skill ID identifying a skill of the worker, and data of attribute items associated with the worker ID and the skill ID; and

a table of priority data including at least data of attribute items and data of priority, in which:

the data of attribute items is configured to include at least data of skill levels representing a degree of proficiency of the skill;

the data of priority represents a priority of each of the data of attribute items for the purpose of selecting a worker to be assigned to the task, the computer includes:

a means for assigning a highest order to the priority of the data of skill levels; and

a means for selecting a worker to be assigned for each of the tasks and the prescribed periods, based on data of required workers representing a number of workers having a required skill for each of the tasks and the prescribed periods, and the priority data, in order of descending values of the data of skill levels, the data of required workers being calculated from predicted values of workload for each prescribed period.

By utilizing the computer of the seventh aspect, it is possible to anticipate a similar effect as with the first aspect.

According to an eighth aspect of the present invention, in the computer as described in the seventh aspect, the data of attribute items further includes data of work efficiency calculated based on an average handle time for one task;

the means for assigning a highest order to the priority assigns a highest order to the priority of the data of work efficiency, for a case in which values of the data of skill levels relating to a plurality of the worker ID's are mutually equal; and

the means for selecting selects the worker in order of descending values of the data of work efficiency.

By utilizing the computer of the eighth aspect, it is possible to anticipate a similar effect as with the second aspect.

According to a ninth aspect of the present invention, in the computer as described in the eighth aspect, the data of attribute items further includes data of affiliations representing an affiliation of the worker;

the means for assigning a highest order to the priority assigns a highest order to the priority of the affiliation data, for a case in which values of the data of skill levels in relation to a plurality of the worker ID's are mutually identical, and values of the data of work efficiency in relation to a plurality of the worker ID's are mutually identical; and

the means for selecting selects the worker based on a ratio of the number of workers registered with each of the affiliations.

By utilizing the computer of the ninth aspect, it is possible to anticipate a similar effect as with the third aspect.

According to a tenth aspect of the present invention, in the computer as described in the ninth aspect, the means for selecting selects the workers by generating random numbers for a case in which values of the data of skill levels relating to the plurality of worker ID's are mutually equal, values of the data of work efficiency relating to the plurality of worker ID's are mutually equal, and values of the data of affiliations relating to the plurality of worker ID's are mutually equal.

By utilizing the computer of the tenth aspect, it is possible to anticipate a similar effect as with the fourth aspect.

According to an eleventh aspect of the present invention, the computer as described in the ninth or tenth aspect further includes a means for displaying on a display portion a number of workers for each of the affiliations selected based on a ratio of a number of the workers registered with each of the affiliations, and accepts a modifying input of the number of workers displayed, in which

the means for selecting re-selects workers assigned for each of the prescribed periods based on a ratio of the number of workers for which the modifying input has been accepted.

By utilizing the computer of the eleventh aspect, it is possible to anticipate a similar effect as with the fifth aspect.

According to a twelfth aspect of the present invention, the computer as described in any one of the seventh to eleventh aspects further includes a means for accepting an input for configuring the priority data.

By utilizing the computer of the twelfth aspect, it is possible to anticipate a similar effect as with the sixth aspect.

According to a thirteenth aspect of the present invention, a program that causes a computer to select workers to be assigned for each task,

the computer storing in a storage unit: a table of skill attributive items of workers including at least a worker ID identifying a worker, a skill ID identifying a skill of the worker, and data of attribute items associated with the worker ID and the skill ID, and

a table of priority data including at least data of attribute items and data of priority, in which:

the data of attribute items is configured to include at least data of skill levels representing a degree of proficiency of the skill;

the data of priority represents a priority of each of the data of attribute items for the purpose of selecting a worker to be assigned to the task, the program causes the computer to execute:

a step of assigning a highest order to the priority of the data of skill levels; and

a step of selecting a worker to be assigned for each of the tasks and the prescribed periods, based on data of required workers representing a number of workers having a required skill for each of the tasks and the prescribed periods, and the priority data, in order of descending values of the skill level data, the data of required workers being calculated from predicted values of workload for each prescribed period.

By executing the program of the thirteenth aspect by way of the computer, it is possible to anticipate a similar effect as with the first aspect.

According to a fourteenth aspect of the present invention, in the program as described in the thirteenth aspect, the data of attribute items further includes data of work efficiency calculated based on an average handle time for one task,

the program causes the computer to:

assign a highest order to the priority of the work efficiency data in the step of assigning highest order to the priority, for a case in which values of the data of skill levels relating to a plurality of the worker ID's are mutually equal; and

select the workers in descending order of values of the data of work efficiency in the step of selecting.

By executing the program of the fourteenth aspect by way of the computer, it is possible to anticipate a similar effect as with the second aspect.

According to a fifteenth aspect of the present invention, in the program as described in the fourteenth aspect, the data of attribute items further includes data of affiliations representing an affiliation of the worker;

the program causes the computer to:

assign a highest order to the priority of the affiliation data in the step of assigning highest order to the priority, for a case in which values of the data of skill levels relating to a plurality of the worker ID's are mutually equal, and values of the data of work efficiency relating to a plurality of the worker ID's are mutually equal; and

select the workers based on a ratio of the number of workers registered for each of the affiliations in the step of selecting.

By executing the program of the fifteenth aspect by way of the computer, it is possible to anticipate a similar effect as with the third aspect.

According to a sixteenth aspect of the present invention, in the program as described in the fifteenth aspect, the program causes the computer to select the workers by generating random numbers in the step of selecting, for a case in which values of the data of skill levels relating to the plurality of worker ID's are mutually equal, values of the data of work efficiency relating to the plurality of worker ID's are mutually equal, and values of the data of affiliations relating to the plurality of worker ID's are mutually equal.

By executing the program of the sixteenth aspect by way of the computer, it is possible to anticipate a similar effect as with the fourth aspect.

According to a seventeenth aspect of the present invention, the program as described in the fifteenth or sixteenth aspect further includes a step of causing the computer to display on a display portion a number of workers for each of the affiliations of workers selected based on a ratio of the number of workers registered for each of the affiliations, and accepting a modifying input of the number of workers displayed; and

in the step of selecting, based on a ratio of the number of workers for which the modifying input has been accepted, workers assigned for each prescribed period are re-selected.

By executing the program of the seventeenth aspect by way of the computer, it is possible to anticipate a similar effect as with the fifth aspect.

According to an eighteenth aspect of the present invention, the program as described in any one of the thirteenth to seventeenth aspects further executes, by way of the computer, a step of accepting an input for configuring the priority data.

By executing the program of the eighteenth aspect by the computer, it is possible to anticipate a similar effect as with the sixth aspect.

### Effects of the Invention

According to the present invention, it is possible for the computer, by deciding upon a priority of attribute items, to select a worker to be assigned for each of the tasks and the prescribed periods, based on the calculated data of required workers, data of priority, and data of attribute items. As a result, the computer, based on the data of priority, can select a worker, and there is a possibility of being able to carry out an assignment plan minimizing excesses and deficiencies of workers and mismatches of skills.

### BRIEF DESCRIPTION OF THE DRAWINGS

FIG. 1 is a block diagram illustrating a configuration of a computer 10 relating to a preferred embodiment of the present invention;

FIG. 2 is a schematic diagram illustrating an overall configuration of a computer system 1 relating to a preferred embodiment of the present invention;

FIG. 3 is a main flow diagram illustrating a computer 10 carrying out worker selection processing relating to a preferred embodiment of the present invention;

FIG. 4 is a flow diagram illustrating priority data configuration processing relating to a preferred embodiment of the present invention;

FIG. 5 is a diagram illustrating a priority data table relating to a preferred embodiment of the present invention;

FIG. 6 is a flow diagram illustrating assigned worker selection processing relating to a preferred embodiment of the present invention;

FIG. 7 is a diagram illustrating a required worker by task table relating to a preferred embodiment of the present invention;

FIG. 8 is a diagram illustrating a worker skill attribute item table relating to a preferred embodiment of the present invention;

FIG. 9 is a diagram illustrating a scheduling by task table relating to a preferred embodiment of the present invention;

FIG. 10 is a diagram illustrating a worker skill attribute item table relating to a preferred embodiment of the present invention;

FIG. 11 is a diagram illustrating a scheduling by task table relating to a preferred embodiment of the present invention;

FIG. 12 is a diagram illustrating a worker skill attribute item table relating to a preferred embodiment of the present invention;

FIG. 13 is a diagram illustrating a scheduling by task table relating to a preferred embodiment of the present invention;

FIG. 14 is a diagram illustrating a worker skill attribute item table relating to a preferred embodiment of the present invention;

FIG. 15 is a diagram illustrating a scheduling by task table relating to a preferred embodiment of the present invention;

FIG. 16 is a diagram illustrating a schedule by assigned company screen relating to a preferred embodiment of the present invention;

FIG. 17 is a diagram illustrating a schedule by assigned company screen relating to a preferred embodiment of the present invention;

FIG. 18 is a diagram illustrating a schedule by assigned company screen relating to a preferred embodiment of the present invention; and

FIG. 19 is a diagram illustrating a priority designation screen relating to a preferred embodiment of the present invention.

### DESCRIPTION OF THE SYMBOLS

1 computer system
10 computer
20 server
30 communication network
40 terminal
50 PBX
60 telephone line network
110 controller
120 memory unit
130 input unit
140 display unit
150 communication controller
160 bus

### PREFERRED MODE FOR CARRYING OUT THE INVENTION

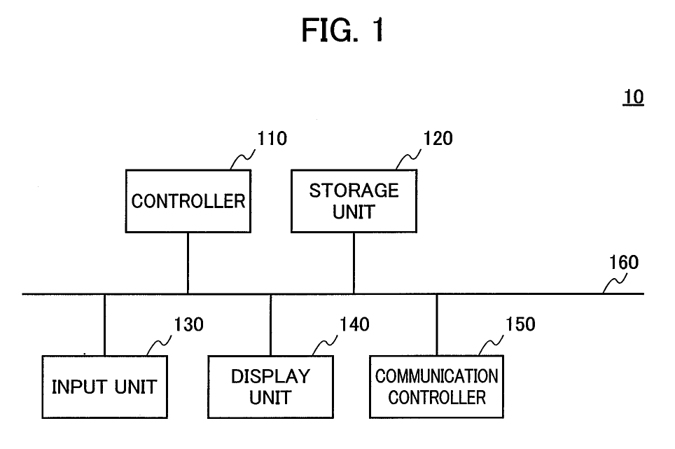

An embodiment of the present invention is explained below based on the drawings. FIG. 1 is a block diagram illustrating a configuration of a computer 10 relating to a preferred embodiment of the present invention.

A computer 10 is composed of a controller 110, a memory unit 120, an input unit 130, a display unit 140, and a communication controller 150 connected together through a bus 160.

The controller 110 is an information calculation processing device (CPU) carrying out calculation and processing of information, and carries out control of the computer 10 overall. The controller 110, by suitably reading and executing various programs stored in the memory unit 120, functions collaboratively with the abovementioned hardware, and realizes various functions relating to the present invention.

The memory unit 120 may include a local memory and a high-capacity bulk memory for use in executing a program in combination with the controller 110, and a cache memory for use in carrying out efficient search of the bulk memory. The memory device 120 as a computer readable storage medium may include such memories as electrical, magnetic, optical and electromagnetic memories. More specifically, semiconductor storage devices, magnetic tapes, floppy (registered trademark) disks, random access memory (RAM), read-only memory (ROM), and optical discs, including CD-ROMs, CD-R/Ws, and DVDs, and the like, are included.

The input unit 130 carries out accepting of input by a user, and may include a keyboard, a pointing device, and the like. The input unit 130 may be connected to the computer directly or through an intermediate I/O controller

The display unit 140 is a device to display a screen to a user for accepting input of data, or for displaying results of calculation processing performed by the computer on a screen, and includes display devices such as a cathode-ray tube (CRT), a liquid-crystal display (LCD), and the like.

Here, a communication controller 150 is a network adapter for the purpose of enabling the computer to connect through a special network or public network to another calculation processing system or storage device. The communication controller 150 may include a modem, a cable modem, and an Ethernet (registered trademark) adapter.

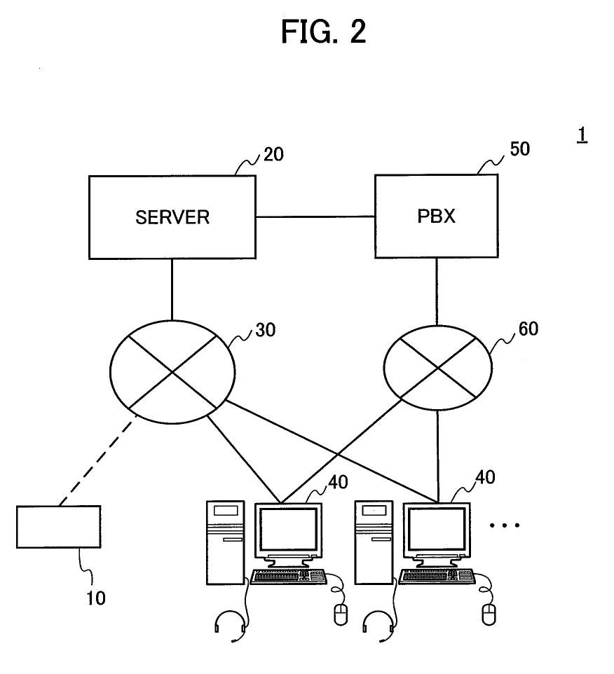

Moreover, the configurations of the server 20, terminal 40, and PBD 50 to be described later in FIG. 2 are similar to the computer 10. Furthermore, the terminal 40 provides an analog telephone line jack and LAN connector as communication controller 150, enabling telephone conversation by a headset, mouse, and keyboard.

FIG. 2 is a schematic diagram illustrating an overall configuration of a computer system 1 relating to a preferred embodiment of the present invention. In this system, the computer 10, server 20, and terminal 40 are configured to be mutually connected through a communication network 30. Furthermore, the server 20 and the PBX 50 are mutually connected. In addition, the terminal 40 and the PBX 50 are mutually connected through a telephone line network 60.

Moreover, it is not necessarily required that the computer 10 be connected through the communication network 30 to the server 20.

The server 20 stores data of past work record per skill possessed by an operator (hereafter referred to as “worker”), and carries out various processing, such as sending the data of past work record to the computer 10 and the like.

Moreover, the server 20 may be realized as a so-called CTI server carrying out routing of inbound calls in tandem with the PBX 50 in a call center or a contact center, or carrying out making outbound calls in tandem with an ACD.

Here, in the embodiment, an example of carrying out a task using a telephone is explained, but a technical scope of the invention is not limited to this, and even in a case of using electronic mail to carry out correspondence to clients, it is possible to apply the principle of the present invention.

The computer 10 carries out various processing to be described later.

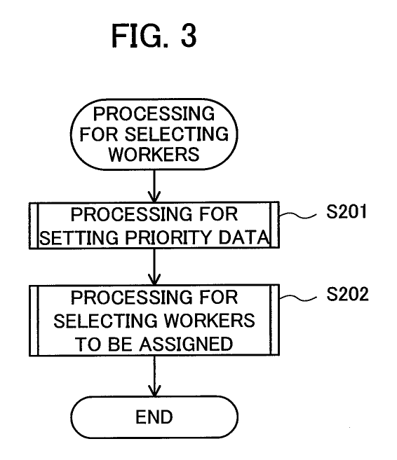

FIG. 3 is a main flow for carrying out processing for selecting workers carried out by a computer 10 relating to a preferred embodiment of the present invention. The following describes thereof based on the drawings.

The controller 110, in step S201, carries out processing for setting priority data.

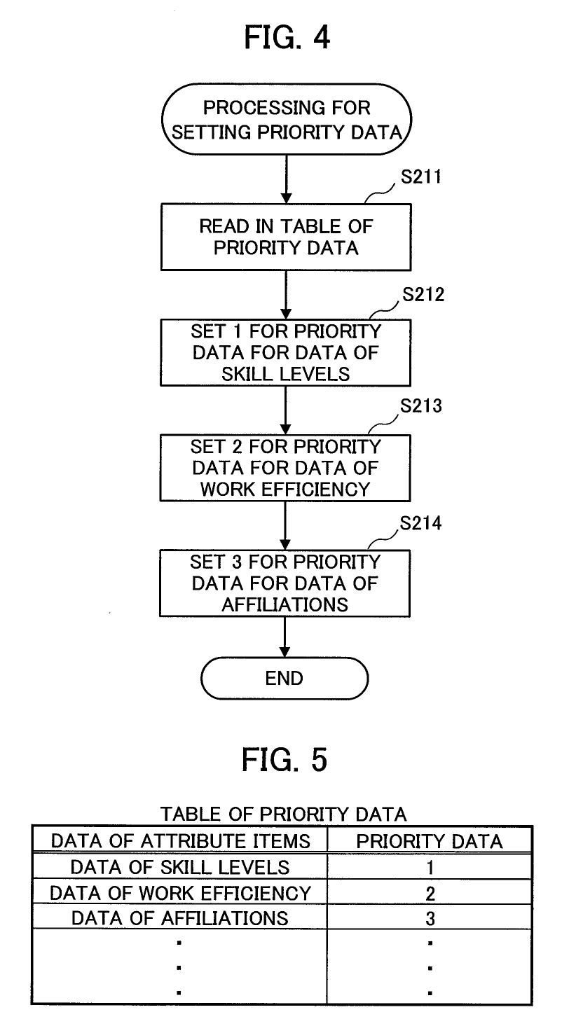

Here, a description is given of the processing for setting priority data illustrated in FIG. 4.

The controller 110 reads in a table of priority data in Step S211. The computer 10 stores the table of priority data beforehand in the storage unit 120.

The table of priority data indicated in FIG. 5 is a table storing a priority for each of the data of attribute items. Here, according to a priority for each of the data of attribute items, a worker to be assigned is selected. For example, in a case in which data of skill levels has priority data of “1”, and data of work efficiency has priority data of “2”, the skill level is prioritized in selecting a worker to be assigned. This processing carrying out selection of a worker to be assigned is described later.

Returning to FIG. 4, next, the controller 110, in Step S212, assigns “1” to priority data corresponding to the data of skill levels. Next, the controller 110, in Step S213, assigns “2” to priority data corresponding to the data of work efficiency.

Next, the controller 110, in Step S214, assigned “3” to priority data corresponding to data of affiliations, and terminates the processing for setting priority data.

When the processing for setting priority data finishes, as illustrated in FIG. 5, a state is illustrated in which “1” as priority data corresponding to the data of skill levels, “2” as priority data corresponding to the data of work efficiency, and “3” as priority data corresponding to the data of affiliations, have each been assigned.

Returning to FIG. 3, the controller 110 carries out processing for selecting workers to be assigned in Step S202.

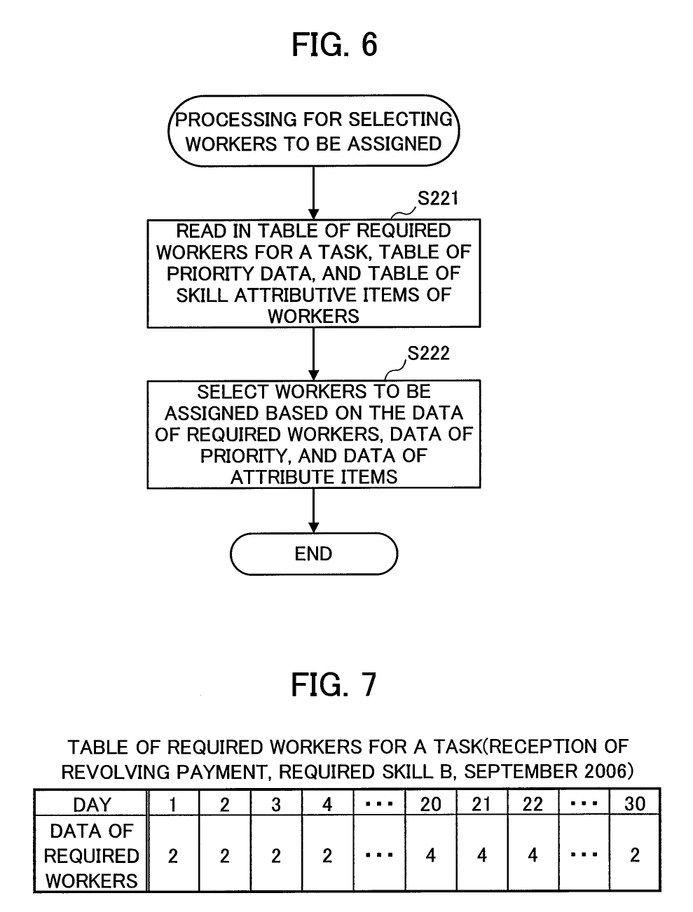

Here, a description is given of the processing for selecting workers to be assigned illustrated in FIG. 6.

The controller 110, in Step S221, reads in a table of required workers for a task, a table of priority data, and a table of skill attributive items of workers. The computer 10 stores in the storage unit 120 the table of priority data, the table of required workers for a task, and the table of skill attributive items of workers.

The table of required workers for a task (reception of revolving payment, required skill B, September 2006) illustrated in FIG. 7 stores a required number of workers (data of required workers) having a required skill per task. For example, the task of reception of revolving payment requires the skill named “B”, and indicates that, on Sep. 20, 2006, 4 people are required.

Returning to FIG. 6, the controller 110, in Step S222, selects workers to be assigned based on the data of required workers, priority data, and data of attribute items. When processing of Step S222 finishes, the controller 110 finishes the processing for selecting workers to be assigned.

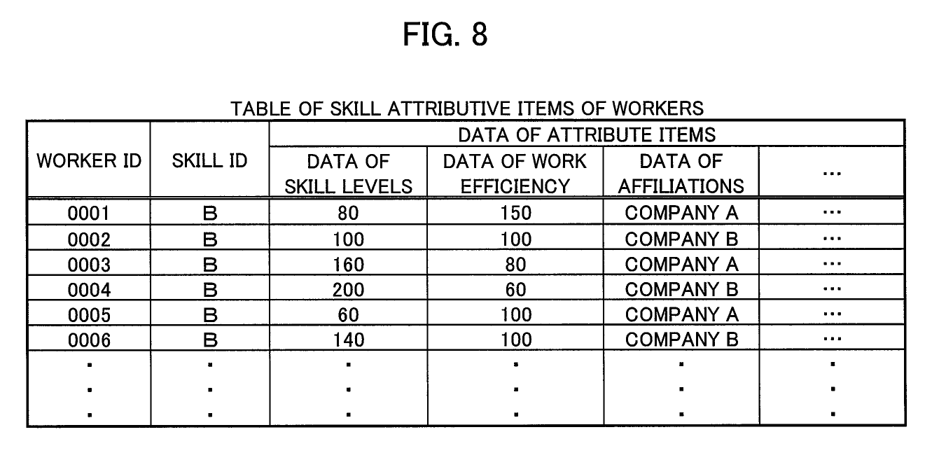

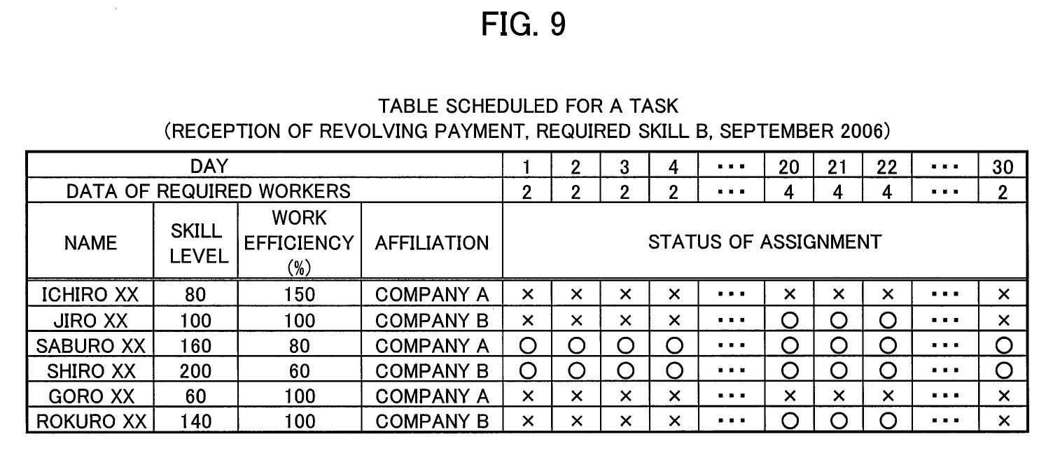

As a method for selecting workers, more specifically, it is possible to use a publicly known method using statistical techniques or AI (artificial intelligence). In addition, the controller 110 selects workers by creating a table scheduled for a task indicated in FIGS. 9, 11, 13, and 15, based on the data of required workers, data of priority, and the data of attribute items of the table of skill attributive items illustrated in FIGS. 8, 10, 12, and 14.

Here, the tables of skill attributive items of workers illustrated in FIGS. 8, 10, 12, and 14 store the data of attribute items (skill level data, work efficiency data, affiliation data, and the like) associated with a skill possessed by each worker.

For example, in FIG. 8, the worker of worker ID “0001” has skill “B”, and the values of the data of skill levels, the data of work efficiency, and the data of affiliates are “80”, “150”, and “Company A”, respectively.

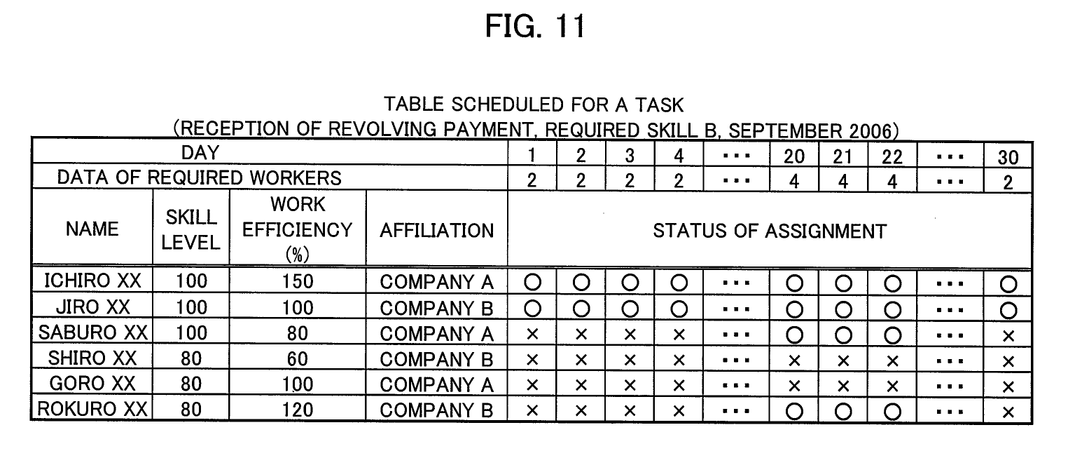

The tables scheduled for a task illustrated in FIGS. 11, 13, and 15 illustrate a status of selection (status of assignment) of workers having a worker ID having a required skill “B” for reception of revolving payment. Here, the full names and worker IDs are associated by the table of correspondence between worker IDs and names (not illustrated), and “Ichiro XX”, “Jiro XX”, “Saburo XX”, “Shiro XX”, “Goro XX”, and “Rokuro XX” each correspond to worker IDs “0001”, “0002”, “0003”, “0004”, “0005”, and “0006”, respectively. Furthermore, if the status of selection is “0”, this indicates that a worker has been assigned on the corresponding day, and if “X”, this indicates no assignment thereof.

First, since an attribute item to which the priority data of “1” is assigned is the data of skill levels, the controller 110 selects workers to be assigned in descending order of values of the data of skill levels.

As illustrated in FIG. 9, required workers on the 2^{nd} are 2 people, and the controller 110 has selected “Shiro XX”, who has a highest value “200” of the data of skill levels illustrated in FIG. 8, and “Saburo XX”, who has a second highest “160” thereof. Furthermore, required workers on the 20^{th} are 4 people, and the controller 110, similarly, has selected “Shiro XX”, “Saburo XX”, “Rokuro XX,” and “Jiro XX”.

Furthermore, since an attribute item with “2” of the priority data is the data of work efficiency, the controller 110, in a case of a plurality of workers who have identical values of the data of skill levels, selects workers to be assigned in descending order of values of the data of work efficiency.

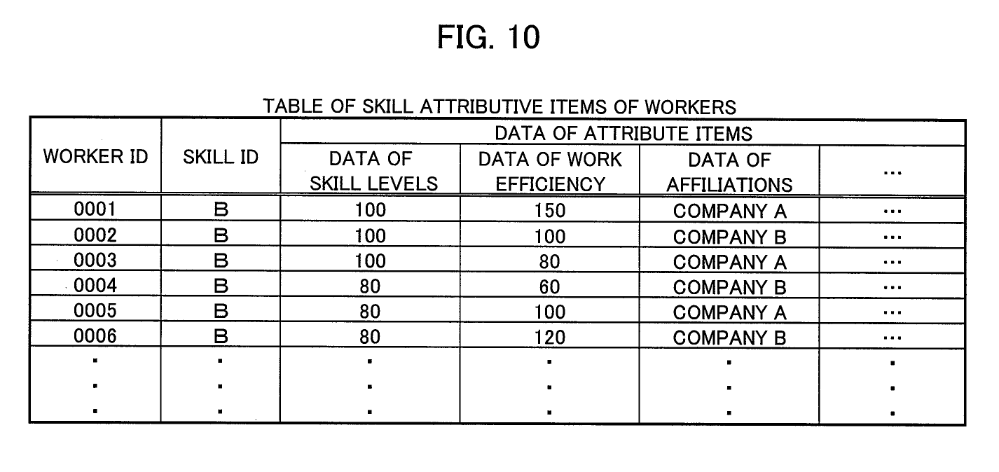

As illustrated in FIG. 11, a required number of workers for the 2^{nd} is 2 people, and the controller 110 has selected from among “Ichiro XX”, “Jiro XX”, and “Saburo XX” having a highest value “100” of the data of skill levels illustrated in FIG. 10, “Ichiro XX”, who has a highest value “150” of the data of work efficiency, and “Jiro XX”, who has a second highest “100” thereof. Furthermore, required workers on the 20^{th} are 4 people, and the controller 110, similarly, has selected “Ichiro XX”, “Jiro XX”, “Saburo XX,” and “Rokuro XX”.

In addition, since an attribute item with “3” of the data of priority is the data of affiliations, the controller 110, in a case of a plurality of workers who have identical values of the data of skill levels and the data of work efficiency, selects workers to be assigned based on a ratio of a number of workers registered at each affiliation.

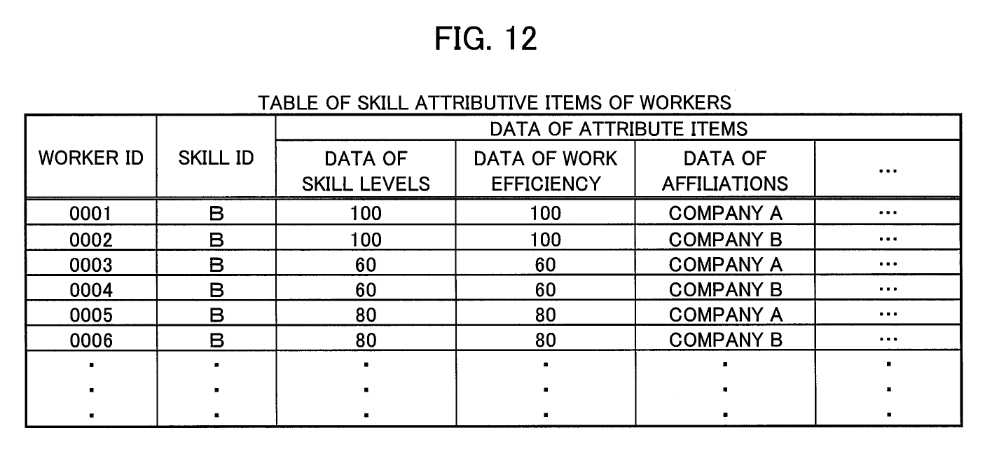

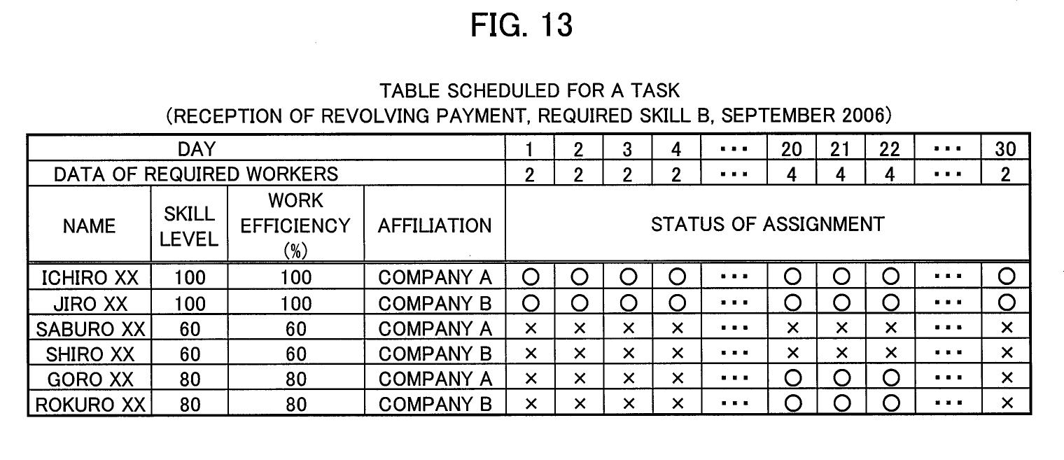

As illustrated in FIG. 13, required workers on the 2^{nd} are 2 people, and values of the data of work efficiency of “Ichiro XX” and “Jiro XX” are each equal at “100”, who have a highest value “100” of the data of skill levels illustrated in FIG. 12. Furthermore, since “Ichiro XX” and “Jiro XX” are each affiliated with “Company A” and “Company B”, respectively, a ratio of a number of workers registered with each affiliation is 1:1. Therefore, the controller 110 has selected “Ichiro XX” and “Jiro XX”. Furthermore, required workers on the 20^{th} are 4 people, and the controller 110, similarly, has selected “Ichiro XX”, “Jiro XX”, “Goro XX,” and “Rokuro XX”.

Furthermore, in a case where a plurality of workers has an identical value of the data of skill levels, an identical value of the data of work efficiency, and an identical value of the data of affiliations, the controller 110 selects a worker to be assigned by generating a random number.

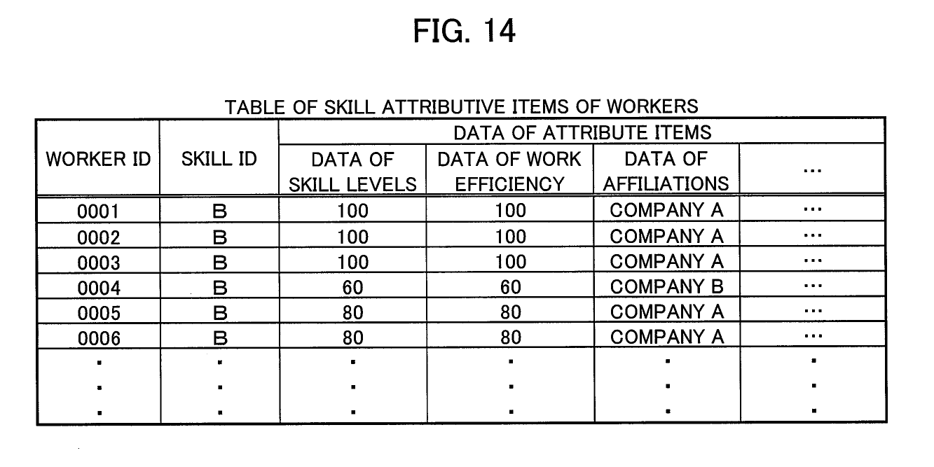

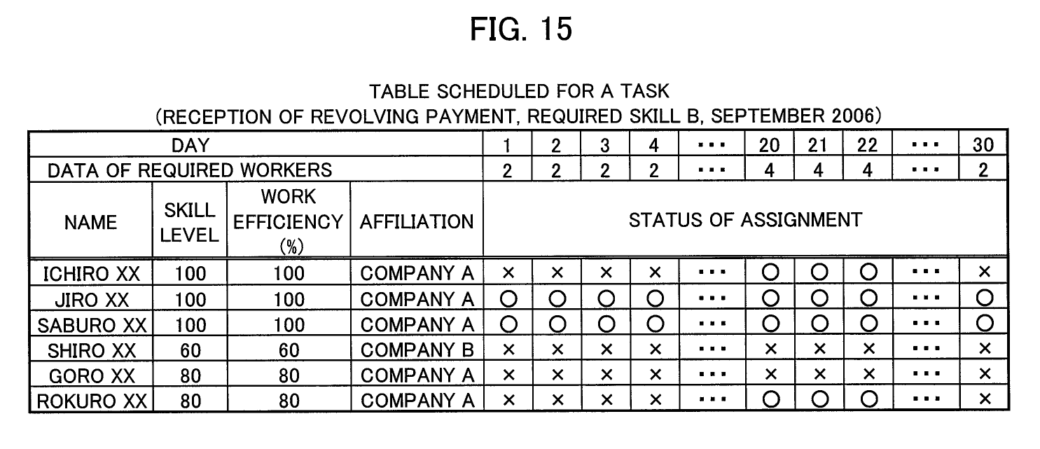

As illustrated in FIG. 15, required workers on the 2^{nd} are 2 people, and values of the data of work efficiency of “Ichiro XX”, “Jiro XX”, and “Saburo XX”, are each equal at “100”, who have a highest value “100” of the data of skill levels illustrated in FIG. 14. Furthermore, since “Ichiro XX”, “Jiro XX”, and “Saburo X” are each affiliated with “Company B” values of affiliation data are also equal. Therefore, the controller 110 has selected “Jiro XX” and “Saburo XX” by generating random numbers. Furthermore, required workers on the 20^{th} are 4 people, and the controller 110, similarly, has selected “Ichiro XX”, “Jiro XX”, “Saburo XX,” and “Rokuro XX”.

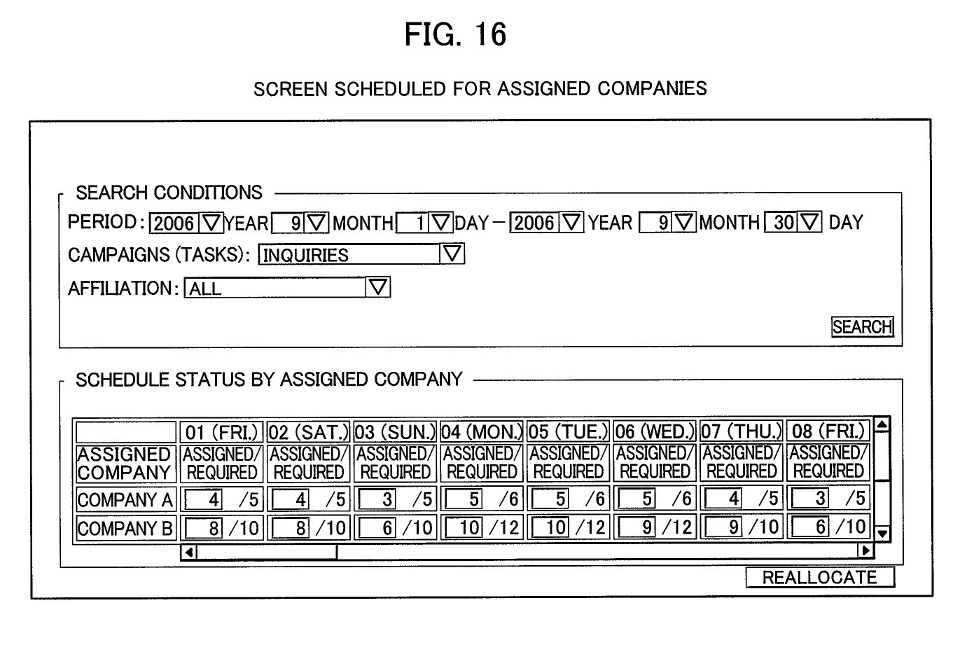

A screen scheduled for each assigned company illustrated in FIG. 16 represents a schedule of one month of workers assigned by each assigned company. For example, the screen indicates that a required number of people for the 3^{rd} for Company A is 5 people and for Company B is 10 people. Furthermore, the screen indicates that an assigned number of people for Company A is 3 people, and for Company B is 6 people. Additionally, a breakdown of required workers is by a ratio of a number of workers registered at each assigned company, and the controller 110 allocates required workers for each day.

In the present embodiment, a ratio of the number of workers is 1:2. Therefore, a total required number of workers for the 3^{rd} being 15 people is indicated. Furthermore, for workers to be assigned also, the controller 110 allocates by a ratio of the number of workers registered.

Here, according to an availability situation of workers affiliated with each assigned company, allocation is not always by a ratio of a number of the registered workers, but depending on circumstances, there are cases in which a need may arise to change an allocation ratio.

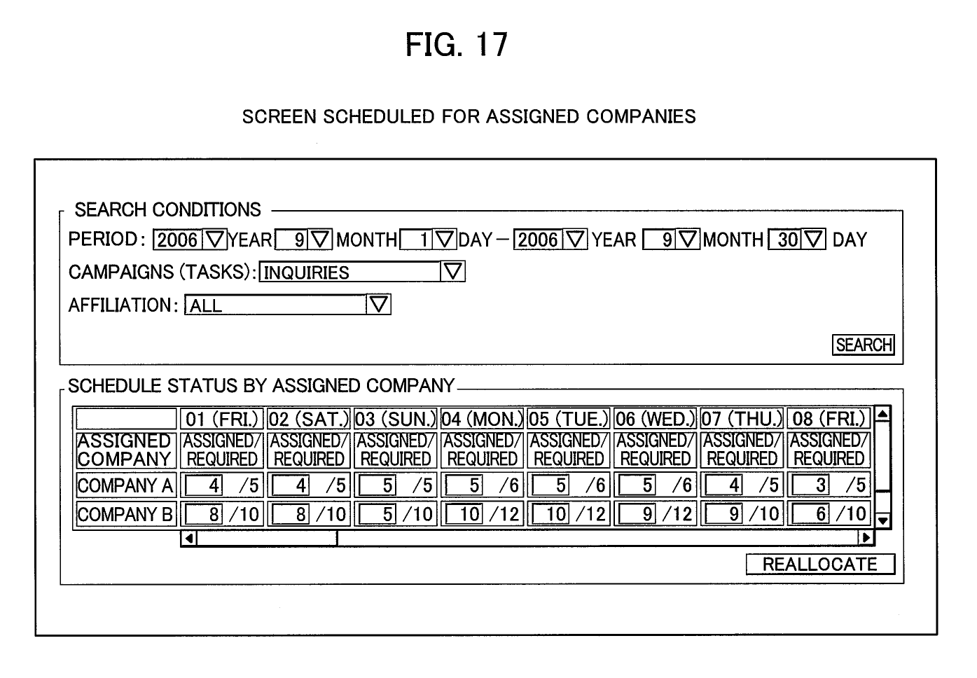

In FIG. 17, a number of assigned workers for the 3^{rd} has been changed to 5 people for Company A, and to 5 people for Company B as well. When a reallocation execution button is pressed, the controller 110 re-selects workers to be assigned according to a changed ratio of workers assigned. For example, in the case of the 3^{rd}, an allocation thereof is performed at 1:1.

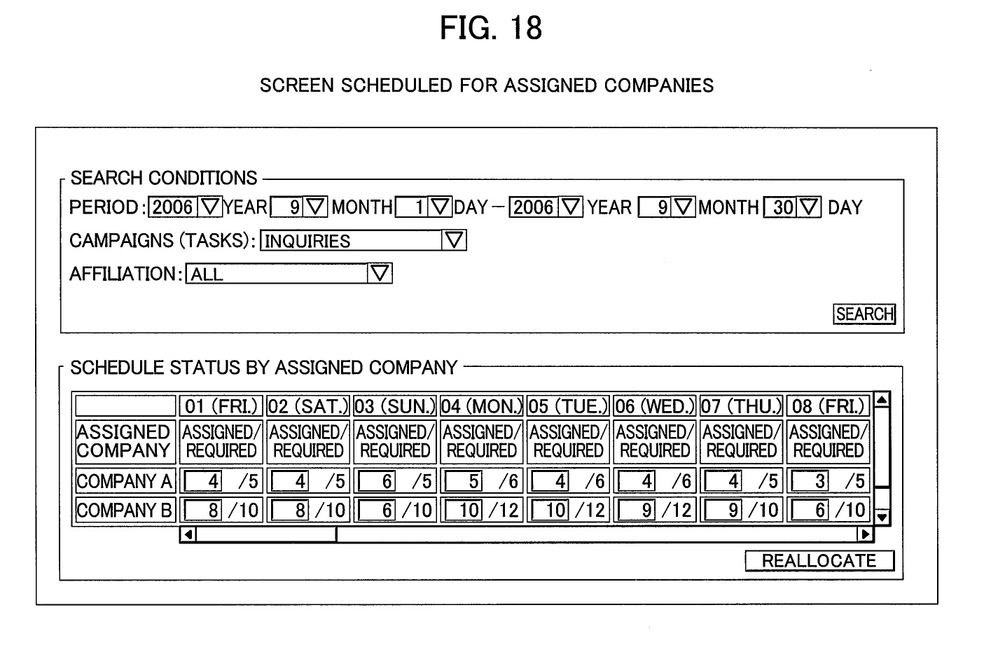

In FIG. 18, results of re-selecting workers to be assigned are illustrated. For example, in the case of the 3^{rd}, the controller 110 has selected so that Company A is 6 people, and Company B is also 6 people. Therefore, for the total required workers of 15 people for the 3^{rd}, the total assigned workers are 12 people. However, since the controller 110 adjustively selects so that a ratio of 1:2 for the total month is approached, assigned workers for Company A regarding the 5^{th} and the 6^{th} are each reduced to 4 people each.

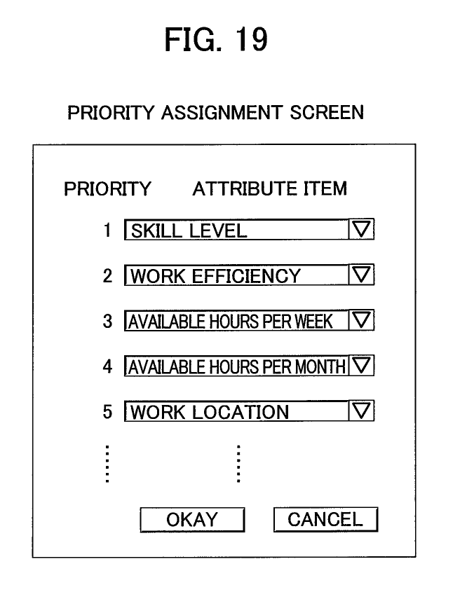

A screen for designating priority illustrated in FIG. 19 is not limited to the attribute items described above, but is a screen designating a priority including other attribute items as well. For example, as other attribute items, there are weekly available hours, monthly available hours, and the like.

Furthermore, for each priority, by designating an attribute item in a list box and pressing a confirmation button, it is possible to configure a priority for each attribute item.

In the present embodiment, daily scheduling has been explained; however, monthly or hourly is also acceptable.

As above, an embodiment of the present invention has been described; however, the present invention is not limited to the above-described embodiment. Furthermore, the effects described in the embodiment of the present invention have only been recited as the most preferable effects generated by the present invention, and the effects of the present invention are not limited to those described in the embodiment of the present invention.

1. A method of a computer selecting a worker to be assigned for each task,
the computer storing in a storage unit a table of skill attributive items of workers comprising at least a worker ID identifying a worker, a skill ID identifying a skill of the worker, and data of attribute item associated with the worker ID and the skill ID, and
a table of priority data comprising at least data of attribute items and data of priority, wherein:
the data of attribute items is configured to comprise at least data of skill levels representing a degree of proficiency of the skill;
the data of priority represents a priority of each of the data of attribute items for the purpose of selecting a worker to be assigned to the task, and wherein:
the method comprises the steps of the computer:
assigning a highest order to the priority of the data of skill levels; and
selecting a worker to be assigned for each of the tasks and the prescribed periods, based on data of required workers representing a number of workers having a required skill for each of the tasks and the prescribed periods, and the data of priority, in order of descending values of the data of skill levels, the data of required workers being calculated from predicted values of workload for each prescribed period.

2. The method according to claim 1, wherein:
the data of attribute items further comprises data of work efficiency calculated based on an average handle time for one task;
in the step of assigning a highest order to the priority, the computer assigns a highest order to the priority of the data of work efficiency for a case in which values of the data of skill levels relating to a plurality of the worker ID's are mutually equal; and
in the step of selecting, the computer selects the workers in descending order of values of the data of work efficiency.

3. The method according to claim 2, wherein:
the data of attribute items further comprises data of affiliations representing an affiliation of the worker;
in the step of assigning a highest order to the priority, the computer assigns a highest order to the priority of the affiliation data, for a case in which values of the data of skill levels relating to a plurality of the worker ID's are mutually equal, and values of the data of work efficiency relating to a plurality of the worker ID's are mutually equal; and
in the step of selecting, the computer selects the workers based on a ratio of a number of the workers registered for each of the affiliations.

4. The method according to claim 3, wherein, in the step of selecting, the computer selects the workers by generating random numbers for a case in which values of the data of skill levels relating to the plurality of worker ID's are mutually equal, values of the data of work efficiency relating to the plurality of worker ID's are mutually equal, and values of the data of affiliations relating to the plurality of worker ID's are mutually equal.

5. The method according to claim 3 or 4, further comprising a step of the computer displaying on a display portion a number of workers for each of the affiliations of workers selected based on a ratio of a number of the workers registered for each of the affiliations, and accepting a modifying input of the number of workers displayed, wherein
in the step of selecting, based on a ratio of the number of workers for which the modifying input has been accepted, workers to be assigned for each prescribed period are re-selected.

6. The method according to any one of claims 1 to 5, further comprising a step of the computer accepting an input for configuring the data of priority.

7. A computer for selecting workers to be assigned for each task,
the computer storing in a storage unit: a table of skill attributive items of workers comprising at least a worker ID identifying a worker, a skill ID identifying a skill of the worker, and data of attribute items associated with the worker ID and the skill ID, and
a table of priority data comprising at least data of attribute items and data of priority, wherein:
the data of attribute items is configured to comprise at least data of skill levels representing a degree of proficiency of the skill; and
the data of priority represents a priority of each of the data of attribute items for the purpose of selecting a worker to be assigned to the task, wherein
the computer comprises:
a means for assigning a highest order to the priority of the data of skill levels; and
a means for selecting a worker to be assigned for each of the tasks and the prescribed periods, based on data of required workers representing a number of workers having a required skill for each of the tasks and the prescribed periods, and the data of priority, in order of descending values of the skill level data, the data of required workers being calculated from predicted values of workload for each prescribed period.

8. The computer according to claim 7, wherein:
the data of attribute items further comprises data of work efficiency calculated based on an average handle time for one task;
the means for assigning a highest order to the priority assigns a highest order to the priority of the data of work efficiency, for a case in which values of the data of skill levels relating to a plurality of the worker ID's are mutually equal; and
the means for selecting selects the worker in order of descending values of the data of work efficiency.

9. The computer according to claim 8, wherein:
the data of attribute items further comprises data of affiliations representing an affiliation of the worker;
the means for assigning a highest order to the priority assigns a highest order to the priority of the data of affiliations, for a case in which values of the data of skill levels in relation to a plurality of the worker ID's are mutually equal, and values of the data of work efficiency in relation to a plurality of the worker ID's are mutually equal; and
the means for selecting selects the worker based on a ratio of the number of workers registered with each of the affiliations.

10. The computer according to claim 9, wherein the means for selecting selects the workers by generating random numbers for a case in which values of the data of skill levels relating to the plurality of worker ID's are mutually equal, values of the data of work efficiency relating to the plurality of worker ID's are mutually equal, and values of the data of affiliations relating to the plurality of worker ID's are mutually equal.

11. The computer according to claim 9 or 10, further comprising a means for displaying on a display portion a number of workers for each of the affiliations selected based on a ratio of a number of the workers registered with each of the affiliations, and accepting a modifying input of the number of workers displayed, wherein
the means for selecting re-selects workers to be assigned for each of the prescribed periods based on a ratio of the number of workers for which the modifying input has been accepted.

12. The computer according to any one of claims 7 to 11, further comprising a means for accepting an input for configuring the data of priority.

13. A program for selecting workers to be assigned for each task by a computer,
the computer storing in a storage unit: a table of skill attributive items of workers comprising at least a worker ID identifying a worker, a skill ID identifying a skill of the worker, and data of attribute items associated with the worker ID and the skill ID, and
a table of priority data comprising at least data of attribute items and data of priority, wherein:
the data of attribute items is composed to comprise at least data of skill levels representing a degree of proficiency of the skill;
the data of priority represents a priority of each of the data of attribute items for the purpose of selecting a worker to be assigned to the task,
the program causing the computer to execute the steps of:
assigning a highest order to the priority of the data of skill levels; and
selecting a worker to be assigned for each of the tasks and the prescribed periods, based on data of required workers representing a number of workers having a required skill for each of the tasks and the prescribed periods, and the priority data, in order of descending values of the skill level data, the data of required workers being calculated from predicted values of workload for each prescribed period.

14. The program according to claim 13, wherein:
the data of attribute items further comprises data of work efficiency calculated based on an average handle time for one task; and
the program causes the computer to:
assign a highest order to the priority of the data of work efficiency in the step of assigning a highest order to the priority, for a case in which values of the data of skill levels relating to a plurality of the worker ID's are mutually equal; and
select the workers in descending order of values of the data of work efficiency in the step of selecting.

15. The program according to claim 14, wherein:
the data of attribute items further comprises data of affiliations representing an affiliation of the worker; and
the program causes the computer to:
assign a highest order to the priority of the data of affiliations in the step of assigning a highest order to the priority, for a case in which values of the data of skill levels relating to a plurality of the worker ID's are mutually equal, and values of the data of work efficiency relating to a plurality of the worker ID's are mutually equal; and
select the workers in the step of selecting based on a ratio of the number of workers registered for each of the affiliations.

16. The program according to claim 15, wherein the program selects the workers by the computer generating random numbers in the step of selecting for a case in which values of the data of skill levels relating to the plurality of worker ID's are mutually equal, values of the data of work efficiency relating to the plurality of worker ID's are mutually equal, and values of the data of affiliations relating to the plurality of worker ID's are mutually equal.

17. The program according to claim 15 or 16, further comprising a step to cause the computer to display on a display portion a number of workers for each of the affiliations of workers selected based on a ratio of the number of workers registered for each of the affiliations, and to accept a modifying input of the number of workers displayed, wherein
the program causes the computer to re-select workers to be assigned for each prescribed period in the step of selecting, based on a ratio of the number of workers for which the modifying input has been accepted.

18. The program according to any one of claims 13 to 17, further causing the computer to execute a step of accepting an input for configuring the data of priority.
